(19) United States
(12) Patent Application Publication
(10) Pub. No.: US 2013/0099713 A1
(43) Pub. Date: Apr. 25, 2013

(54) METHOD FOR INCREASING ROTATION SPEED OF SPINDLE MOTOR

(71) Applicant: QUANTA STORAGE INC., Taoyuan County (TW)

(72) Inventors: Sheng-Wen Chiu, Taoyuan County (TW); Tsung-Ming Huang, Taoyuan County (TW); Miller Yang, Taoyuan County (TW); Shih-Jung Huang, Taoyuan County (TW)

(73) Assignee: QUANTA STORAGE INC., Taoyuan County (TW)

(21) Appl. No.: 13/649,095

(22) Filed: Oct. 10, 2012

(30) Foreign Application Priority Data
Oct. 21, 2011 (TW) 100138460

(51) Int. Cl. H02P 1/04

(52) U.S. Cl. 318/460

(57) ABSTRACT

A method is disclosed to increase a rotation speed of a spindle motor, which comprises: setting a predetermined rotation speed; increasing the rotation speed of the spindle motor to the predetermined rotation speed; recording a critical rotation speed of the spindle motor; decreasing the rotation speed of the spindle motor to the critical rotation speed and remaining at the critical rotation speed for a predetermined time; and increasing the rotation speed of the spindle motor to the working rotation speed for eliminating vibration noise.

### BACKGROUND OF THE INVENTION

1. Field of the Invention

The invention relates to an optical disk drive, and more particularly, to a method for increasing a rotation speed of a spindle motor of the optical disk drive to eliminate vibration and noise.

2. Description of the Prior Art

An optical disk drive uses a spindle motor to rotate an optical disk at high speed, and a pickup head moves along a radial direction of the optical disk to read and write data on the optical disk. A stable rotation of the optical disk can not only increase exactness of reading and writing of the pickup head, but also reduce uncomfortable feelings of users caused by the vibration.

FIG. 1 shows a timing diagram of increasing a rotation speed of the spindle motor in U.S. Pat. No. 7,028,320. This prior art discloses a method for reducing the stable rotation speed of an automatic ball balancing system is used with an automatic ball balancing system that has a spindle motor that has an annular track, with a plurality of balls provided for rotation inside the track. During time t1 to time t4 of increasing a rotation speed of the spindle motor, the fierce vibration generated by the critical rotation speed ωc is avoided, and remain at a lower predetermined rotation speed ωs to make the balls to move to the optimal position of balance to enter the stable rotating state. After entering the stable rotating state, the rotation speed of the spindle motor is increased to a working rotation speed ω, so as to eliminate vibration noise.

However, the balls are affected by obstruction of friction such as surface roughness, dust, or moisture in the annular track, and the balls may not achieve the optimal position of balance. When the balls has not achieved the optimal position of balance, weight of the balls will make unbalance of the optical disk much more seriously, and cause unbalance rotation to increase vibration and noise. Thus, there still remains a problem of the vibration noise in the prior art.

### SUMMARY OF THE INVENTION

One objective of the present invention is to provide a method for increasing a rotation speed of a spindle motor to make the rotation speed of the spindle motor to remain at a critical rotation speed to make balls to detach obstruction easily to achieve an optimal position of balance, so as to reduce time of increasing the rotation speed.

Another objective of the present invention is to provide a method for increasing a rotation speed of a spindle motor by increasing the rotation speed of the spindle motor to a predetermined rotation speed, recording a critical rotation speed, decreasing the rotation speed to the critical rotation speed, and increasing the rotation speed to the working rotation speed after remaining at the critical rotation speed for a short time, so as to eliminate vibration noise efficiently.

To achieve the abovementioned objectives, the method for increasing a rotation speed of a spindle motor of the present invention comprises: setting a predetermined rotation speed, wherein the predetermined rotation speed is higher than a critical rotation speed of a resonance frequency and lower than the working rotation speed; increasing the rotation speed of the spindle motor directly over the critical rotation speed to the predetermined rotation speed; recording the critical rotation speed of the spindle motor; decreasing the rotation speed of the spindle motor to the critical rotation speed; remaining at the critical rotation speed for a predetermined short time; and increasing the rotation speed of the spindle motor to a working rotation speed to eliminate vibration noise.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a timing diagram of increasing a rotation speed of the spindle motor in the prior art.

FIG. 2 shows a structure of a spindle motor with balls.

FIG. 3 shows a timing diagram of increasing a rotation speed of the spindle motor in the present invention.

FIG. 4 shows a vibration curve generated by increasing the rotation speed of the spindle motor in the present invention.

FIG. 5 is a flowchart showing the method for increasing a rotation speed of a spindle motor of the present invention.

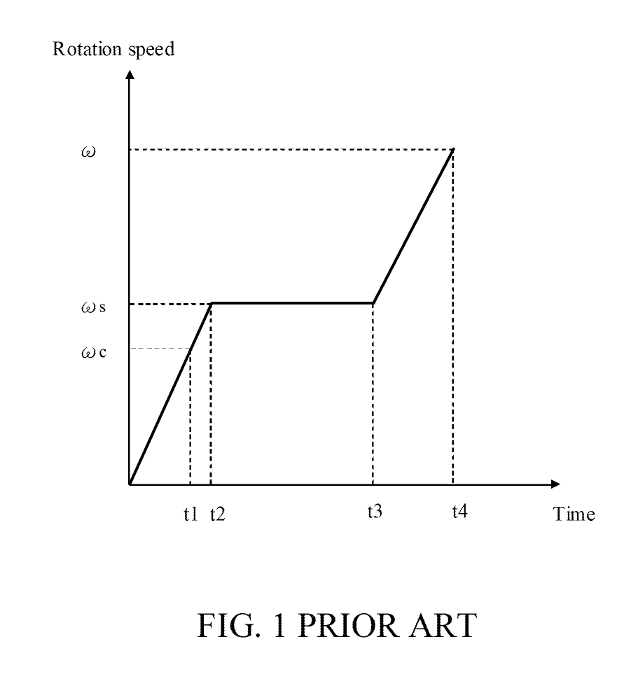

### DETAILED DESCRIPTION

In order to achieve the abovementioned objectives of the present invention, the adopted technical means and effects are described below by illustrating embodiments with drawings.

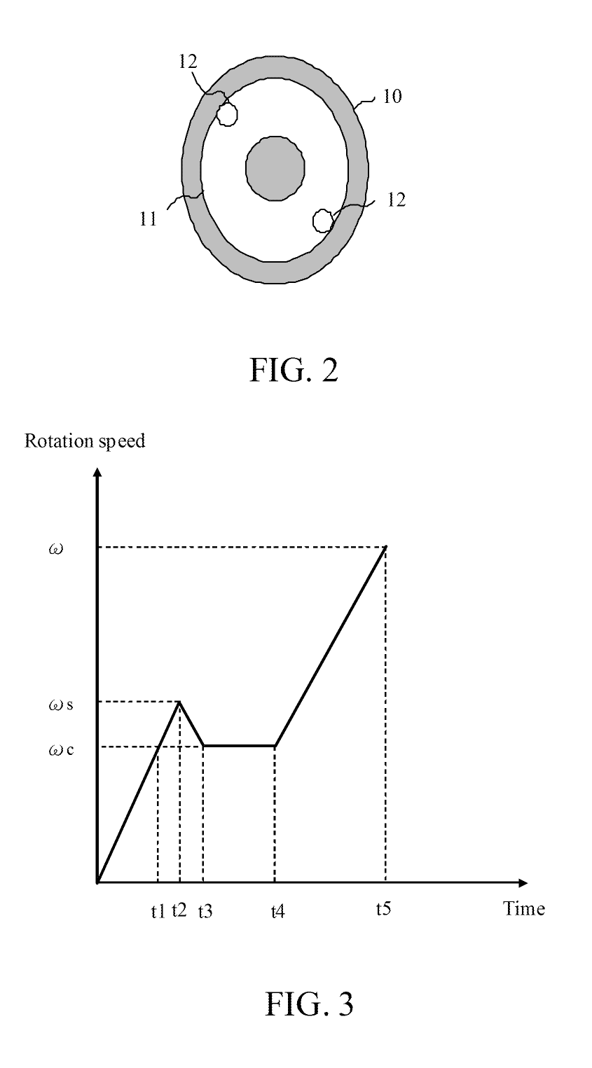

Please refer to FIG. 2 and FIG. 3 simultaneously. FIG. 2 shows a structure of a spindle motor 10 with balls. FIG. 3 shows a timing diagram of increasing a rotation speed of the spindle motor in the present invention. As shown in FIG. 2, a plurality of balls 12 are disposed in an annular track 11 of the spindle motor 10, and the balls 12 can move arbitrarily in the annular track 11. When the spindle motor 10 starts to rotate an optical disk (not shown), the balls 12 are driven by centrifugal force to move along an outer ring wall of the annular track 11.

FIG. 3 shows variation of the rotation speed of the spindle motor 10 in the present invention during time t1 to t5. A predetermined rotation speed ωs is required to be set before increasing the rotation speed of the spindle motor. The predetermined rotation speed ωs is set to be higher than a critical rotation speed ωc of a resonance frequency of an ordinary optical disk drive and lower than a working rotation speed, so as to prevent the spindle motor 10 from generating a fierce vibration at high rotation speed when the spindle motor 10 has not been rotating stably yet. The rotation speed of the spindle motor 10 is constantly increased from 0 to the predetermined rotation speed ωs. The spindle motor 10 reaches the resonance frequency at time t1, and the vibration suddenly becomes bigger. The rotation speed of the spindle motor 10 is recorded as a critical rotation speed ωc of the optical disk drive, and the rotation speed of the spindle motor is directly over the critical rotation speed ωc. When the rotation speed of the spindle motor 10 reaches the predetermined rotation speed ωs at time t2, the rotation speed of the spindle motor 10 is decreased immediately.

The rotation speed of the spindle motor 10 is decreased until reaching the critical rotation speed ωc at time t3, and the rotation speed of the spindle motor 10 is remained at the critical rotation speed ωc initial time t4. During a short time between time t3 and time t4, since the critical rotation speed ωc makes the vibration more fierce, the balls 12 affected by friction such as surface roughness, dust, or moisture in the annular track 11 can detach obstruction easily to achieve an optimal position of balance. Although the critical rotation speed ωc makes the vibration more fierce, the balls 12 can achieve the optimal position of balance quickly, and not only the vibration time is relatively short, but it also can ensure the stable rotating status of the spindle motor 10. Next, the rotation speed of the spindle motor 10 is increased to a working rotation speed ω at time t5, so as to eliminate vibration noise.

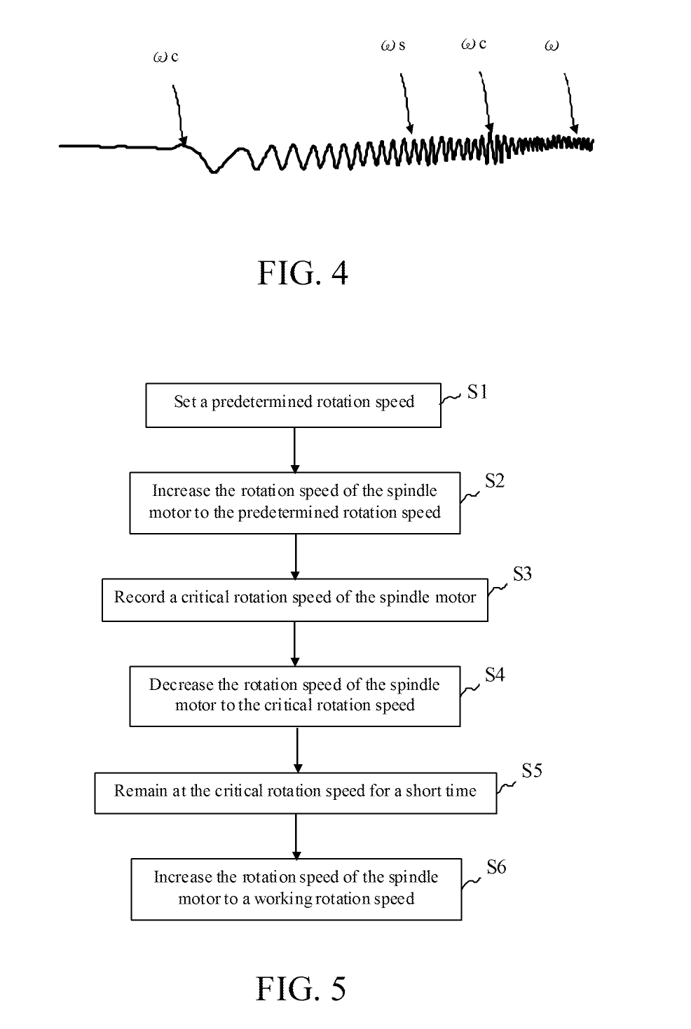

In a practical test of the present invention, the rotation speed of the spindle motor 10 is increased to 6000 rpm, which is directly over the resonance frequency 2750 rpm of the optical disk drive, and then decreases the rotation speed of the spindle motor 10 to the resonance frequency 2750 rpm of the optical disk drive, and increases the rotation speed of the spindle motor 10 to the working rotation speed 9600 rpm after remaining at the resonance frequency 2750 rpm for a short time. FIG. 4 shows a vibration curve generated by increasing the rotation speed of the spindle motor 10 in the present invention. As shown in FIG. 4, when the rotation speed just achieves the critical rotation speed ωc, the vibration becomes bigger. During increasing the rotation speed of the spindle motor 10 to the predetermined rotation speed ωs and decreasing the rotation speed of the spindle motor 10 to the critical rotation speed ωc, there is still a vibration since the balls 12 has not achieved the optimal position of balance to enter the stable rotating state yet. When the rotation speed of the spindle motor 10 is decreased to the critical rotation speed ωc, a bigger vibration appears at an initial stage, but the bigger vibration appears only for a short time. The vibration becomes smaller when the rotation speed of the spindle motor 10 is increased to the working rotation speed ω and leaves the critical rotation speed ωc. Thus, the balls 12 has achieved the optimal position of balance to enter the stable rotating state.

FIG. 5 is a flowchart showing the method for increasing a rotation speed of a spindle motor of the present invention. The method for increasing a rotation speed of a spindle motor of the present invention comprises the steps as following: In step S1, set a predetermined rotation speed higher than a critical rotation speed of a resonance frequency and lower than the working rotation speed. In step S2, increase the rotation speed of the spindle motor directly over the critical rotation speed to the predetermined rotation speed. In step S3, record the critical rotation speed of the spindle motor. In step S4, decrease the rotation speed of the spindle motor to the critical rotation speed. In step S5, remain at the critical rotation speed for a predetermined time, wherein the predetermined time is a short time. In step S6, increase the rotation speed of the spindle motor to a working rotation speed.

Therefore, the method for increasing a rotation speed of a spindle motor of the present invention can utilize increasing the rotation speed of the spindle motor to a predetermined rotation speed, recording a critical rotation speed, decreasing the rotation speed to the critical rotation speed, remaining at the critical rotation speed for a short time to make balls to detach obstruction easily to achieve an optimal position of balance to enter the stable rotating state by using the vibration generated by the critical rotation speed, and increasing the rotation speed to the working rotation speed, so as to eliminate vibration noise efficiently and reduce time of increasing the rotation speed.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for increasing a rotation speed of a spindle motor with balls, comprising:
(1) setting a predetermined rotation speed;
(2) increasing the rotation speed of the spindle motor to the predetermined rotation speed;
(3) recording a critical rotation speed of the spindle motor;
(4) decreasing the rotation speed of the spindle motor to the critical rotation speed and remaining at the critical rotation speed for a predetermined time; and
(5) increasing the rotation speed of the spindle motor to a working rotation speed.

2. The method of claim 1, wherein the critical rotation speed is a resonance frequency of the spindle motor.

3. The method of claim 2, wherein the predetermined rotation speed is higher than the resonance frequency.

4. The method of claim 1, wherein the predetermined rotation speed is lower than the working rotation speed.

5. The method of claim 1, wherein when increasing the rotation speed of the spindle motor to the predetermined rotation speed, the rotation speed of the spindle motor is directly over the critical rotation speed.

6. The method of claim 1, wherein the predetermined time is a short time.
